(19) United States
(12) Patent Application Publication
(10) Pub. No.: US 2007/0030776 A1
(43) Pub. Date: Feb. 8, 2007

(54) Super-resolution information recording medium, recording/reproducing apparatus, and recording/reproducing method

(75) Inventors: Joo-ho Kim, Yongin-si (KR); In-oh Hwang, Seongnam-si (KR); Narutoshi Fukuzawa, Tokyo (JP); Junji Tominaga, Ibaraki (JP); Takashi Kikukawa, Tokyo (JP); Tatsuhiro Kobayashi, Tokyo (JP); Takashi Nakano, Ibaraki (JP); Takayuki Shima, Ibaraki (JP)

Correspondence Address: STEIN, MCEWEN & BUI, LLP, 1400 EYE STREET, NW, SUITE 300, WASHINGTON, DC, 20005, US

(73) Assignees: Samsung Electronics Co., Ltd., Suwon-si (KR); National Institute of Advanced Industrial Science and Technology, Tokyo (JP)

(21) Appl. No.: 11/499,712

(22) Filed: Aug. 7, 2006

(30) Foreign Application Priority Data
Aug. 8, 2005 (KR) 2005-72334

(51) Int. Cl. G11B 19/02; G11B 3/70

(52) U.S. Cl. 369/47.1; 369/288

(57) ABSTRACT

A super-resolution information recording medium, a recording/reproducing apparatus, and a recording/reproducing method uses an information recording medium provides a super-resolution effect by fluid bubbles. The fluid bubbles are formed in at least a portion of the medium by a light beam radiated to reproduce a signal from the information recording medium. Accordingly, the super-resolution information recording medium has improved optical characteristics, so that better recording/reproduction is possible.

### CROSS-REFERENCE TO RELATED APPLICATIONS

This application claims the benefit of Korean Application No. 2005-72334, filed on Aug. 8, 2005 in the Korean Intellectual Property Office, the disclosure of which is incorporated herein by reference.

### BACKGROUND OF THE INVENTION

1. Field of the Invention

Aspects of the present invention relate to a recording/reproducing apparatus for recording data to or reproducing data from a super-resolution information recording medium, and a recording/reproducing method performed by the recording/reproducing apparatus.

2. Description of the Related Art

Optical discs, which are optical information recording media, are widely used in recording and reproduction of various types of information, such as, audio data or video data. Examples of the optical discs include compact discs, digital video discs, blu-ray discs, high-density DVDs, etc. The digital video discs, the blu-ray discs, and the high-density DVDs are involved in the controversy over the standards for the next-generation of optical discs.

During developments from first-generation CD standards to third-generation HD-DVD standards, a storage capacity of optical recording media was increased by decreasing a track pitch gradually from 1.60 μm to 0.74 μm to 0.32 μm, and decreasing a minimal mark length gradually from 0.83 μm to 0.40 μm to 0.149 μm. The storage capacity of optical recording media may also be increased by reducing the wavelength of a laser beam or by increasing the numerical aperture (NA) of an objective lens. However, current technology is limited in generating a laser beam with a short wavelength, and an objective lens having a large NA is costly.

When a wavelength of a light source used in a reproducing apparatus is λ, and the numerical aperture of an objective lens used therein is NA, λ/4NA is a reproduction resolution limit. Accordingly, although it is possible to form extremely small recording marks, reproduction based on the small recording marks may be impossible in a conventional optical recording disc. That is, in the conventional art, light radiated from the light source cannot recognize recording marks whose sizes are smaller than λ/4NA, and thus information reproduction is impossible although forming small recording marks is possible.

To overcome the reproduction resolution limit in the conventional optical recording disc, a super-resolution disc including a metal oxide film and a phase change film from which a super-resolution effect is obtained have been recently studied. As for such a super-resolution disc, when reproduction power of a light source becomes a certain power level or greater, a laser spot induced local high-temperature area of a phase change film melts. It is considered that a super-resolution effect is obtained due to a difference between optical characteristics of a melted portion and a non-melted portion of the phase change film. By using the super-resolution effect, it is possible to reproduce information from recording marks whose sizes are smaller than a resolution limit of a laser beam focused on an information recording medium by an objective lens.

FIG. 1 illustrates a region where a super-resolution phenomenon occurs in a spot of a reproduction beam projected onto a conventional super-resolution information recording medium.

Referring to FIG. 1, marks 110 whose sizes are greater than a resolution limit are recorded along a track 100 of the conventional super-resolution information recording medium. Since a temperature distribution change or an optical property change occurs due to a difference in light intensity in a part of an optical spot 120 formed on a super-resolution layer of the medium, information can be reproduced even from the marks 110 that are smaller than the resolution limit. In other words, it is considered that a temperature distribution change or an optical characteristic change occurs in a particular region of the optical spot 120, while this change does not occur in a peripheral region 140 around the particular region. The particular region where the change occurs is a center region of the optical spot 120 as shown in FIG. 1 or may be a rear portion of the optical spot 120. The particular region where the change occurs constitutes a super-resolution region 130. The division of such particular region where an optical characteristic change occurs from the other region within an optical spot may be concentric or non-concentric.

FIG. 2 is a graph showing a carrier-to-noise ratio (C/N) versus reproduction power of a light beam in a super-resolution optical disc in accordance with a conventional art. For example, when an optical system in which λ is 405 nm and NA is 0.85 is used, a reproduction resolution limit, λ/4NA, is about 119 nm. FIG. 2 illustrates a C/N versus reproduction power when information is reproduced from 75 nm marks, which are smaller than the reproduction resolution limit, on a conventional super-resolution optical disc including a metal oxide film and a phase change film. Referring to FIG. 2, the C/N is about 40 dB at reproduction power of about 1.2 mW or more. Accordingly, a signal is detected at the reproduction power of about 1.2 mW or more.

In such a super-resolution disc having a metal oxide film and a phase change film, and providing a super-resolution effect, when reproduction power becomes a predetermined power level or greater, a laser spot induced local high-temperature region of the phase change film melts. At this time, the super-resolution effect is obtained due to a difference between optical characteristics of a melted portion and a non-melted portion of the phase change film. A micro structure of a portion the phase change film that is solid becomes different from that of a portion of the phase change film that is melted and solidified.

Optical recording media having such a super-resolution structure can be widely used by satisfying recording characteristics and reproduction characteristics that are basic requirements of information recording media. The most important one of the basic recording characteristics and reproduction characteristics is the C/N. In particular, an improvement of the C/N is important in information recording media having a super-resolution near-field structure because they use a recording beam and a reproduction beam both having a higher power than those used in general information recording media.

### SUMMARY OF THE INVENTION

Aspects of the present invention include a super-resolution information recording medium, a recording/reproducing apparatus, and/or a recording/reproducing method, by which the optical characteristics of the super-resolution information recording medium are improved to thereby provide better recording/reproduction.

According to an aspect of the present invention, there is an information recording medium having a super-resolution effect, the medium including fluid bubbles formed in at least a portion of the medium by a light beam radiated to reproduce a signal from the information recording medium.

The portion of the medium may include a part melted by the light beam.

The information recording medium may include at least a layer formed of a material having a low melting point or a low evaporation point.

The material having a low melting point or a low evaporation point may include at least one of Zn, Te, Bi, and Sb.

The material having a low melting point or a low evaporation point may be AgInSbTe.

The information recording medium may further include a layer formed of a metal oxide.

The metal oxide may be PtOx.

According to another aspect of the present invention, there is a recording/reproducing apparatus for recording data to or reproducing data from an information recording medium having a super-resolution effect, the apparatus including a pickup unit irradiating a light beam with predetermined power onto the information recording medium and detecting the light beam reflected from a predetermined portion in which fluid bubbles are generated by the light beam, and a control unit controlling the pickup unit to irradiate the light beam with predetermined power onto the information recording medium and processing an optical signal detected by the pickup unit.

The control unit may further control the pickup unit to irradiate the light beam on the information recording medium with sufficiently high power to generate fluid bubbles in the information recording medium.

According to another aspect of the present invention, there is a recording/reproducing method of recording data to or reproducing data from an information recording medium having a super-resolution effect, the method including the operations of irradiating a light beam with predetermined power onto the information recording medium, detecting the light beam reflected from a portion of the information recording medium in which fluid bubbles are generated by the light beam, and processing an optical signal corresponding the detected light beam.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the aspects, taken in conjunction with the accompanying drawings of which:

FIG. 1 illustrates a region where a super-resolution phenomenon occurs in a spot of a reproduction beam projected onto a super-resolution information recording medium;

FIG. 2 is a graph showing a carrier-to-noise ratio (C/N) versus reproduction power in a super-resolution optical disc according to a conventional art;

FIG. 3 illustrates a super-resolution information recording medium according to an aspect of the present invention;

FIG. 4 is a graph showing a threshold power with which fluid bubbles can be formed in a super-resolution information recording medium in accordance with an aspect of the present invention;

FIG. 5 illustrates a cross-section of an information recording medium in which fluid bubbles are formed in a portion of a layer in accordance with an aspect of the present invention;

FIG. 6A illustrates a state of layers of a super-resolution information recording medium according to an aspect of the present invention when it has been just manufactured;

FIG. 6B illustrates a state of layers of the information recording medium of FIG. 6A after being heated;

FIGS. 7A through 7C are views for explaining a principle in which fluid bubbles are formed in the super-resolution information recording medium of FIGS. 6A and 6B;

FIG. 8 is a table showing differences between optical characteristics of a fluid bubble layer according to an aspect of the present invention and a melted portion of a super-resolution layer; and

FIG. 9 illustrates a recording/reproducing apparatus according to an aspect of the present invention.

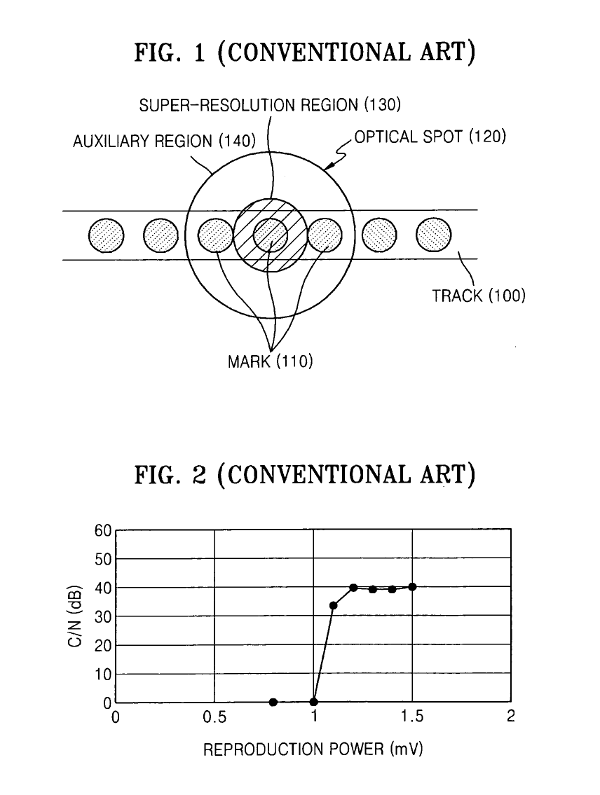

### DETAILED DESCRIPTION OF THE EMBODIMENTS

Reference will now be made in detail to the aspects of the present invention, examples of which are illustrated in the accompanying drawings, wherein like reference numerals refer to the like elements throughout. The aspects are described below in order to explain the present invention by referring to the figures.

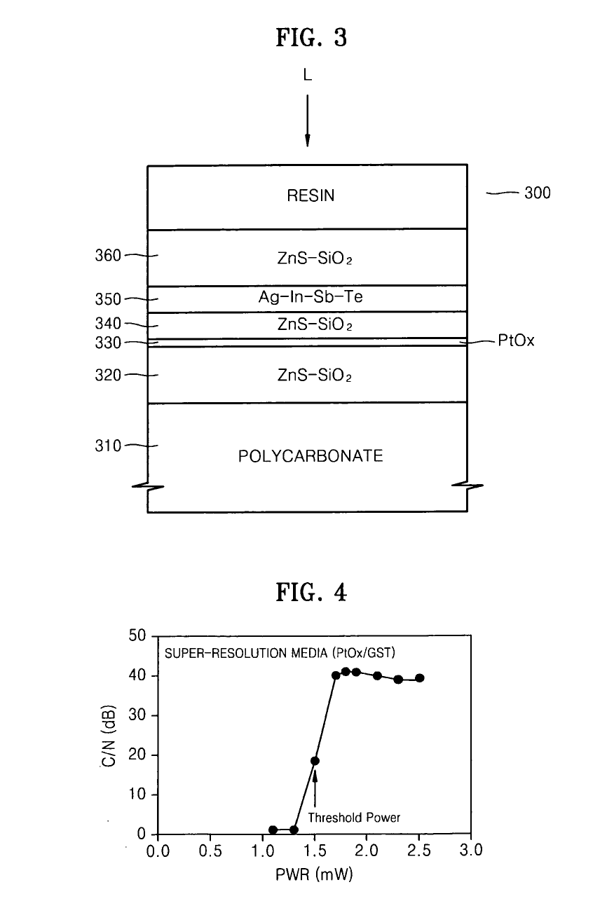

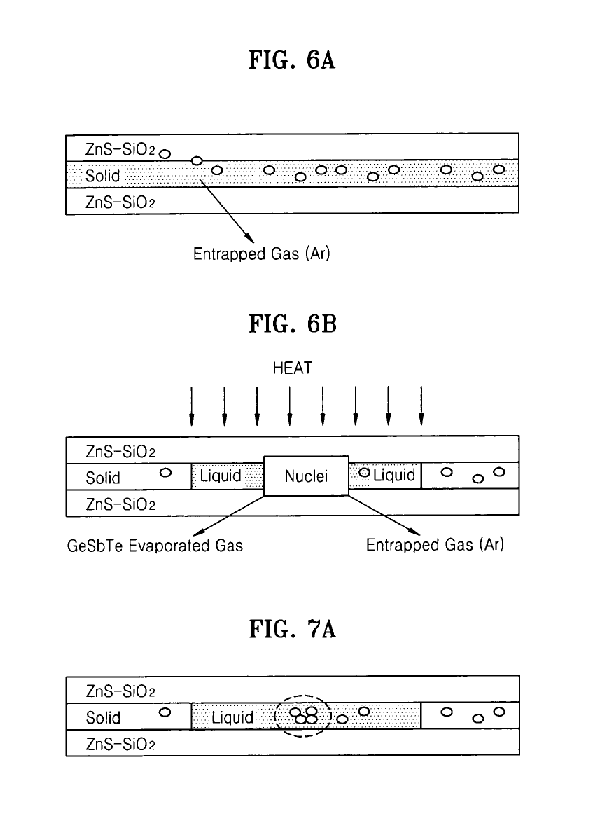

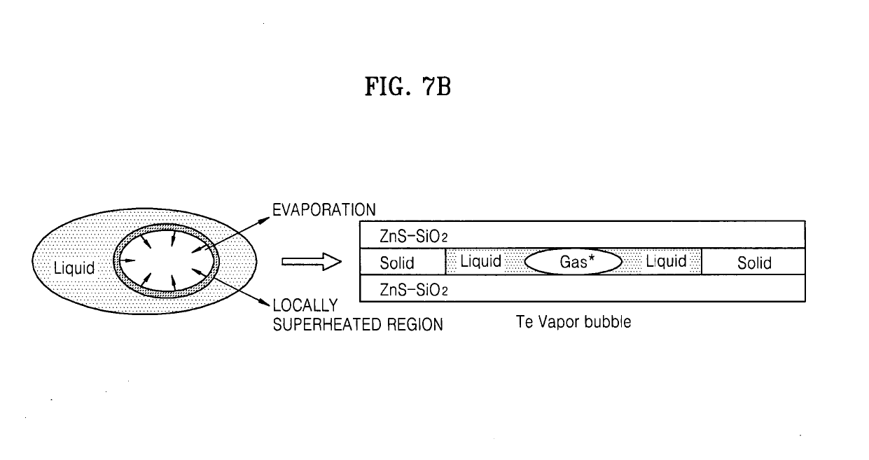

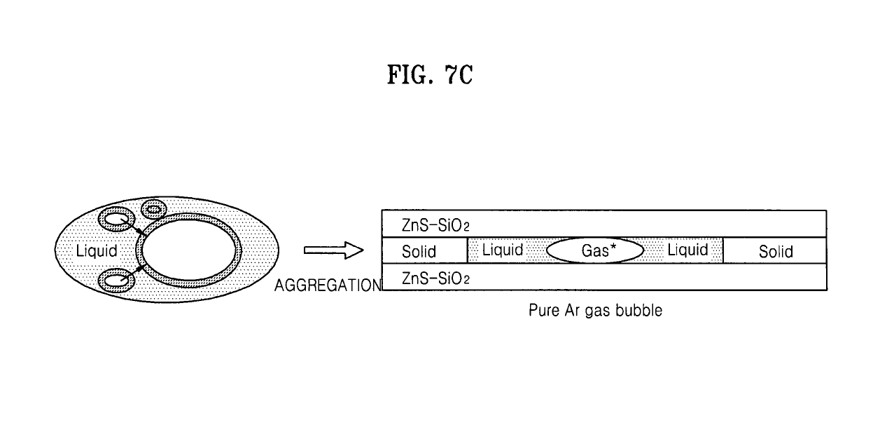

FIG. 3 illustrates a super-resolution information recording medium 300 according to an aspect of the present invention. When a light beam L is irradiated onto the super-resolution information recording medium 300 to reproduce a signal from the medium 300, fluid bubbles (shown in FIGS. 6A-7C) are produced in at least a portion of the medium 300. Thus, the optical characteristics of the super-resolution information recording medium 300 is improved. In the portion of the medium 300 where the fluid bubbles are formed, a melted portion may coexist. Accordingly, the fluid bubbles may contain a vapor, a gas, a liquid, or any combination thereof.

Referring to the aspect of the present invention of FIG. 3, the super-resolution information recording medium 300 includes a substrate 310 formed of polycarbonate, a ZnS—SiO₂ dielectric layer 320 formed on the polycarbonate substrate 310, a recording layer 330 formed of a metal oxide of PtOx, a ZnS—SiO₂ dielectric layer 340, a reproduction auxiliary layer 350 formed of Ag—In—Sb—Te, a ZnS—SiO₂ dielectric layer 360, and a cover layer formed of resin on the ZnS—SiO₂ dielectric layer 360 by spin coating. In a non-limiting aspect of the present invention, the light beam L is a laser beam L that is irradiated into the super-resolution information recording medium 300 through the cover layer, thereby performing information reproduction. In a non-limiting aspect of the present invention, the ratio of the AgInSbTe is about 6:4.4:61:28.6.

In other aspects of the present invention, the reproduction auxiliary layer 350 is not necessarily formed of Ag—In—Sb—Te. Nevertheless, it is preferable, but not required, that the reproduction auxiliary layer 350 is formed of a material having a low melting point or a low evaporation point temperature. In a non-limiting aspect of the present invention, when a melting point temperature of a material is lower than a recording temperature, or when an evaporation point temperature of a material is lower than three times the melting point temperature of the material, recorded information can be properly reproduced from the medium 300 without affecting recorded information. In various aspects of the present invention, the material having a low melting point temperature or a low evaporation point temperature may include Zn, Te, Bi, Sb, or any combination thereof.

In various aspects of the present invention, the reproduction auxiliary layer 350 may include Ge, alone, or in a combination. Additionally, in various aspects of the present invention, the substrate 310 may be any material suitable for use as a substrate of a super-resolution information recording medium. The substrate 310 may also be polymethymethacrylate (PMMA), amorphous polyolefin (APO), glass, or any combination thereof. Additionally, in various aspects of the present invention, any of the dielectric layers 320, 340, 360 may also be an oxide, a nitride, a carbide, a fluoride, a sulfide, or any combination thereof. For example, they may be silicon oxide (SiOx), magnesium oxide (MgOx), aluminum oxide (AlOx), titanium oxide (TiOx), vanadium oxide (VOx), chromium oxide (CrOx), nickel oxide (NiOx), zirconium oxide (ZrOx), germanium oxide (GeOx), zinc oxide (ZnOx), silicon nitride (SiNx), aluminum nitride (AlNx), titanium nitride (TiNx), zirconium nitride (ZrNx), germanium nitride (GeNx), silicon carbide (SiC), zinc sulfide (ZnS), a zinc sulfide-silicon dioxide compound (ZnS—SiO₂), and magnesium fluoride (MgF₂), or any combination thereof.

In various aspects of the present invention, the recording layer 330 may be any suitable metal oxide or a polymer compound. For example, the recording layer 330 may also be gold oxide (AuOₓ), palladium oxide (PdOₓ), silver oxide (AgOₓ), or any combination thereof. C₃₂H₁₈N₈,H₂PC (Phthalocyanine) may also be used as a polymer compound for the recording layer 330.

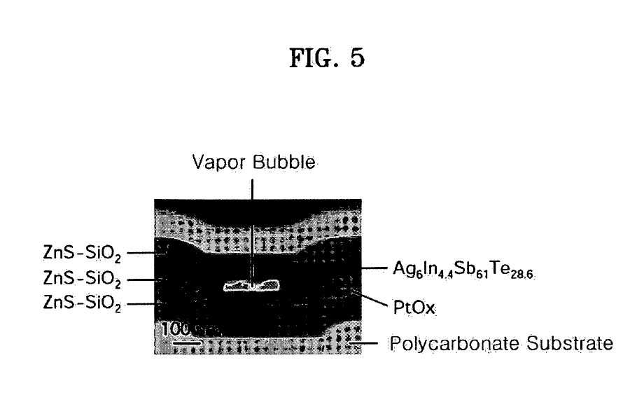

FIG. 4 is a graph showing a threshold power of a light beam with which fluid bubbles can be formed in a super-resolution information recording medium 300 in accordance with an aspect of the present invention. Referring to FIG. 4, a threshold power of the light beam with which fluid bubbles are formed in the super-resolution information recording medium as shown in FIG. 5 is 1.5 mW. Because actual reproduction power is at least 20% higher than the threshold power, it is clear that fluid bubbles are formed during reproduction.

FIG. 5 illustrates a cross-section of an information recording medium in which fluid bubbles are produced in a portion of a layer in accordance with the present invention. Referring to FIG. 5, a portion of an AgInSbTe layer shown is occupied with a fluid bubble. Because the fluid bubble is in a gaseous state, the information recording medium of FIG. 5 has excellent optical characteristics compared with a conventional art in which information is reproduced from a super-resolution recording medium using a melting phenomenon (i.e., a liquid state).

FIG. 6A illustrates a state of layers of a super-resolution information recording medium according to an aspect of the present invention when it has just been manufactured. Referring to FIG. 6A, argon (Ar) gas is entrapped in a reproduction auxiliary layer (corresponding to layer 350 of FIG. 3) in a solid state between two ZnS—SiO₂ dielectric layers (corresponding to layers 340 and 360 of FIG. 3). This is because the reproduction auxiliary layer is formed in an Ar gas atmosphere.

FIG. 6B illustrates a state of the information recording medium of FIG. 6A after being heated by a light source. Referring to FIG. 6B, when heat for signal reproduction is applied to the information recording medium of FIG. 6A, the solid reproduction auxiliary layer melts and becomes liquid. At this time, some of the Ar gas molecules escape and partially aggregate to form a nucleus of an Ar gas bubble.

FIGS. 7A through 7C are views for explaining a principle in which fluid bubble or bubbles that include vapor and/or Ar gas are formed in the super-resolution information recording medium of FIGS. 6A and 6B. Referring to FIG. 7A, when a beam of light starts heating the super-resolution information recording medium and reaches threshold power sufficient to cause a super-resolution effect, the solid reproduction auxiliary layer between the dielectric layers melts to become a liquid. Vapors are produced in the liquid to form a vapor bubble. In other aspects of the present invention, vapors may also be produced directly from the solid reproduction auxiliary layer by sublimation. In non-limiting aspects of the present invention, the vapor bubbles may be mostly gaseous matter surrounded by a thin film of liquid matter. In various aspect of the present invention, the solid reproduction auxiliary layer a phase change material of a solid phase (a first phase). When a light beam is radiated to reproduce a signal from the information recording medium, a portion of the solid phase changes to a liquid (a second phase) and/or a gas (a third phase). Accordingly, a pocket of at least one different phase is formed.

Referring to the aspect of the present invention of FIG. 7B, Te is easily evaporated because its evaporation temperature is about 980° C. Once formed by evaporation, the fine Te vapors tend to grow into a vapor bubble. When fine Te vapors suddenly grow into the vapor bubble, an interface between the liquid and the vapors is produced. Since the thermal conductivity of the vapors is very low, a superheating phenomenon occurs in which the temperature of the interface between the liquid and the vapors increases to a very high level, leading to more vapor production by evaporation of the liquid. Once more vapors are produced, the vapor bubbles grow.

Referring to FIG. 7C, the gas entrapped in the reproduction auxiliary layer may be Ar gas used in the formation of the layer. A process in which the Ar gas bubble grows is the same as that shown in FIG. 7B. In various aspects of the present invention, the formation and growth of a vapor bubble, and the growth of a gas bubble may occur simultaneously and the vapor and gas bubbles may coalesce into a fluid bubble containing a mixed vapor and gas. Consequently, in non-limiting aspect of the present invention, the fluid bubble is Te vapor, Ar gas, or a mixture of Te vapor and Ar gas. In other aspects of the present invention, the vapor component of the bubble will correspond to the underlying composition of the reproduction auxiliary layer, and the gas component of the bubble will correspond to the gas used in the formation of the reproduction auxiliary layer. In non-limiting aspects of the present invention, the fluid bubbles may be mostly gaseous matter surrounded by a thin film of liquid matter

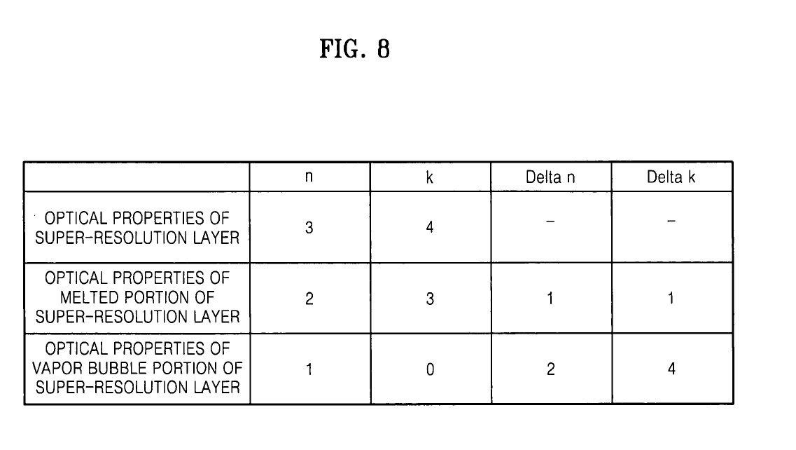

FIG. 8 is a table showing the differences between optical characteristics of a fluid bubble portion of a super-resolution layer according to an aspect of the present invention, optical characteristics of a melted portion of the super-resolution layer, and optical characteristics of a solid portion of the super-resolution layer. Referring to FIG. 8, the super-resolution layer exhibits a super-resolution effect arising from a difference in the optical characteristics of the solid portion and the liquid portion of the super-resolution layer as is the case with a conventional super-resolution layer, which is based on the idea that an effective beam spot for reproduction is formed by melting.

However, as further shown in the table of FIG. 8, in the aspect of the present invention, an effective beam spot for reproduction is formed by fluid bubbles (vapor, gas, and/or liquid) or a mixture of fluid bubbles and a melted portion (liquid). Accordingly, the super-resolution effect arising from a difference in the optical characteristics of the solid and fluid bubbles, or a solid and a mixture of bubbles and liquid, is greater that the super-resolution effect arising from a difference in the optical characteristics of the solid and liquid. Accordingly, a better optical signal is obtained. Referring to FIG. 8, the optical properties of the fluid bubble portion of the super-resolution layer according to the present invention are greatly changed, that is, a refractive index (n) of 1 and an extinction coefficient (k) of 0 are achieved.

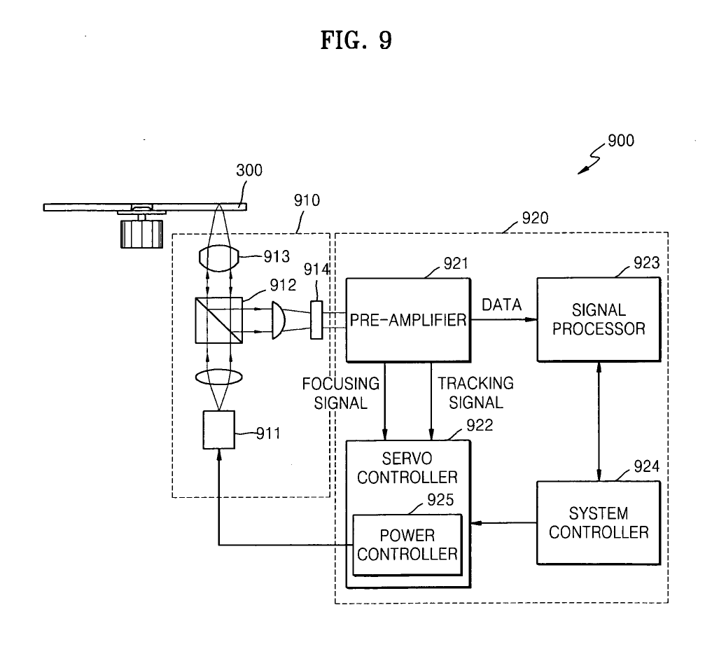

FIG. 9 illustrates a recording/reproducing apparatus 900 according to an aspect of the present invention. Referring to FIG. 9, the recording/reproducing apparatus 900 includes a pickup unit 910 which irradiates a laser beam onto the super-resolution information recording medium 300 and detects the laser beam reflected from the super-resolution information recording medium 300, and a control unit 920 which controls the pickup unit 910. In particular, the control unit 920 controls the pickup unit 910 to irradiate a beam onto the super-resolution information recording medium 300 with sufficiently high power to form fluid bubbles in the super-resolution information recording medium 300.

The pickup unit 910 includes a light source 911, a beam splitter 912 which changes a path of the traveling laser beam, an objective lens 913 which focuses the laser beam heading for the super-resolution information recording medium 300, and a photodetector 914. The light source 911 emits the laser beam having a predetermined power. The photodetector 914 receives the laser beam reflected from the super-resolution information recording medium 300 and transmits the laser beam to the control unit 920.

The control unit 920 performs focusing and tracking control based on an optical signal detected by the photodetector 914 and processes the optical signal to reproduce data. The control unit 920 includes a pre-amplifier 921, a servo controller 922, a signal processor 923, and a system controller 924.

The pre-amplifier 921 produces a focusing signal and a tracking signal from the optical signal detected by the photodetector 914 and provides the focusing signal and the tracking signal to the servo controller 922. The pre-amplifier 921 provides user data to the signal processor 923.

The servo controller 922 performs servo control of the pickup unit 910 using the focusing signal and the tracking signal received from the pre-amplifier 921. In particular, the servo controller 922 includes a power controller 925 for controlling the power of the light source 911 in accordance with the present invention. Preferably, the power controller 925 controls the light source 911 to radiate a laser beam with a sufficiently high power onto the super-resolution information recording medium 300 so that fluid bubbles can be formed therein.

The signal processor 923 receives the data from the pre-amplifier 921, processes the data, and provides the result of the processing to the outside of the recording/reproducing apparatus 900 or to the system controller 924.The system controller 924 controls each of the components of the recording/reproducing apparatus 900.

Although described in terms of a recording/reproducing apparatus, it is understood that aspects of the present invention include an apparatus that records, reproduces, or any combination thereof, in other words, a recording and/or reproducing apparatus.

According to the various aspects of the present invention as described above, recording/reproduction can be improved by enhancing the optical characteristics of a super-resolution information recording medium by a fluid bubble or fluid bubbles of vapor, gas, liquid, or any combination thereof.

Although a few aspects of the present invention have been shown and described, it would be appreciated by those skilled in the art that changes may be made in this aspect without departing from the principles and spirit of the invention, the scope of which is defined in the claims and their equivalents.

What is claimed is:

1. An information recording medium having a super-resolution effect, the medium comprising fluid bubbles formed in at least a portion of the medium by a light beam radiated to reproduce a signal from the information recording medium.

2. The information recording medium of claim 1, wherein the portion of the medium comprises a part melted by the light beam.

3. The information recording medium of claim 1, comprising at least a layer formed of a material having a low melting point or a low evaporation point.

4. The information recording medium of claim 3, wherein the material having a low melting point or a low evaporation point includes at least one of Zn, Te, Bi, and Sb.

5. The information recording medium of claim 3, wherein the material having a low melting point or a low evaporation point is AgInSbTe.

6. The information recording medium of claim 1, further comprising a layer formed of a metal oxide.

7. The information recording medium of claim 6, wherein the metal oxide is PtOx.

8. A recording/reproducing apparatus for recording data to or reproducing data from an information recording medium having a super-resolution effect, the apparatus comprising:
a pickup unit irradiating a light beam with predetermined power onto the information recording medium and detecting the light beam reflected from a predetermined portion in which fluid bubbles are generated by the light beam; and
a control unit controlling the pickup unit to irradiate the light beam with predetermined power onto the information recording medium and processing an optical signal detected by the pickup unit.

9. The recording/reproducing apparatus of claim 8, wherein the control unit further controls the pickup unit to irradiate the light beam on the information recording medium with sufficiently high power to generate fluid bubbles in the information recording medium.

10. The recording/reproducing apparatus of claim 8, wherein the pickup unit detects the light beam using the predetermined portion of the medium where a melted portion and the fluid bubbles generated by the emitted light beam coexist.

11. The recording/reproducing apparatus of claim 8, wherein the pickup unit detects the light beam using a layer that is formed of a material having a low melting point or a low evaporation point and included in the medium.

12. The recording/reproducing apparatus of claim 11, wherein the material having a low melting point or a low evaporation point includes at least one of Zn, Te, Bi, and Sb.

13. The recording/reproducing apparatus of claim 11, wherein the pickup unit detects the light beam by further using a layer that is formed of a material having a metal oxide and included in the medium.

14. A recording/reproducing method of recording data to or reproducing data from an information recording medium having a super-resolution effect, the method comprising:
irradiating a light beam with predetermined power onto the information recording medium;
detecting the light beam reflected from a portion of the information recording medium in which fluid bubbles are generated by the light beam; and
processing an optical signal corresponding the detected light beam.

15. The recording/reproducing method of claim 14, wherein in the irradiating of the light beam, the beam with sufficiently high power is irradiated on the information recording medium to generate fluid bubbles in the information recording medium.

16. The recording/reproducing method of claim 14, wherein in the detecting of the light beam, the light beam is detected using a portion of the medium where a melted portion and the fluid bubbles generated by the emitted light beam coexist.

17. The recording/reproducing method of claim 14, wherein in the detecting of the light beam, the light beam is detected using a layer that is formed of a material having a low melting point or a low evaporation point and included in the medium.

18. The recording/reproducing method of claim 17, wherein the material having a low melting point or a low evaporation point includes at least one of Zn, Te, Bi, and Sb.

19. The recording/reproducing method of claim 17, wherein in the detecting of the light beam, the light beam is detected by further using a layer that is formed of a material having a metal oxide and included in the medium.

20. The information recording medium of claim 1, wherein the fluid bubbles comprise at least one of a vapor, gas, and liquid.

21. The information recording medium of claim 1, wherein the ratio of the AgInSbTe is about 6:4.4:61:28.6.

22. The information recording medium of claim 20, wherein the vapor is Te vapor and gas is Ar gas.

23. The information recording medium of claim 1, wherein the fluid bubble is a thin layer of liquid surrounding at least one of a vapor and a gas.

24. An information recording medium having a super-resolution effect, the medium comprising:
a pair of dielectric layers; and
a phase change material of a first phase disposed between the pair of dielectric layers, wherein a pocket of at least one of a second phase and a third phase is formed in at least a portion of the phase change material by a light beam radiated to reproduce a signal from the information recording medium.

25. The information recording medium of claim 24, wherein the first phase is a solid phase, the second phase is a liquid phase, and the third phase is a gas phase.

26. The information recording medium of claim 24, wherein the phase change material comprises at least one of Zn, Te, Bi, and Sb.

27. The information recording medium of claim 24, wherein the phase change material is AgInSbTe.
